(19) United States
(12) Patent Application Publication
(10) Pub. No.: US 2011/0252595 A1
(43) Pub. Date: Oct. 20, 2011

(54) FITTING MEMBER

(75) Inventors: Katsumi Nagahori, Haga-gun (JP); Tohru Izu, Haga-gun (JP)

(73) Assignee: F. TECH INCORPORATION, Kuki-City (JP)

(21) Appl. No.: 13/089,392

(22) Filed: Apr. 19, 2011

(30) Foreign Application Priority Data
Apr. 20, 2010 (JP) 2010-097336

(51) Int. Cl. F16C 33/04

(52) U.S. Cl. 16/2.5

(57) ABSTRACT

A fitting member is provided with a first end portion, a second end portion facing to the first end portion, and a fitting structure having a first engagement portion and a second engagement portion to connect the first end portion and the second end portion with each other by fitting the first engagement portion and the second engagement portion with each other. The fitting structure is defined by making the first engagement portion and the second engagement portion engaged with each other, while making the second engagement portion formed by punching a preform body of the fitting member through the first engagement portion.

### BACKGROUND OF THE INVENTION

The present invention relates to a fitting member and, more particularly, relates to a fitting member applicable to a strength member for a vehicle such as a motor vehicle.

In recent years, as chassis parts of a vehicle such as a motor vehicle, vibration insulation parts such as several mounts and bushes have been employed. Since such vibration insulation parts are made of rubbers, they have structures in which rubber portions thereof are adhered to collars that are tubular member made of metals and, also, they are inserted into collars provided in strength members such as beams and arms, in general.

Although such collars are required to have improved adhesion properties to the rubbers of the vibration insulation parts or improved workabilities when they are assembled to the strength members, since they are of kinds of strength members, improved strengths thereof are also required.

Under such a situation, Japanese Patent Application Laid-Open Publication No. h1-320332 proposes a bush-type vibration insulation rubber in which an inner cylinder and an outer cylinder are engaged together with convex portions and concave portions formed on at least one of the inner cylinder and the outer cylinder.

Also, Japanese Patent Application Laid-Open Publication No. h9-315124 proposes a cylindrical body for a bush in which convex portions and concave portions are clinched with a joining portion therebetween being welded.

### SUMMARY OF THE INVENTION

Upon studies conducted by the present inventors, however, in Japanese Patent Application Laid-Open Publications No. h1-320332 and No. h9-315124 both mentioned above, it is needed that preform bodies made of plate members, in which the convex portions and the concave portions are preliminarily formed, are prepared and, also, the convex portions and the concave portions are fitted together while bending such preform bodies. Thus, the fitting processes themselves are complicated. In addition, due to dimensional tolerance ranges given in the convex portions and the concave portions, it is thought that engagement faces between the convex portions and the concave portions fitted together are not closely contacted with each other and, resultantly, unnecessary gaps or the like are occurred therebetween. Specifically, in a case that the convex portions and the concave portions are fitted in a dovetail fashion with constricted shapes thereof, it is difficult even to fit the convex portions and the concave portions and, also, there is increased tendency that, if the convex portions and the concave portions are forcedly fitted while prying them, the engagement faces between the convex portions and the concave portions fitted together are not closely contacted with each other.

Also, in Japanese Patent Application Laid-Open Publication No. h9-315124, although the joining portion between the convex portions and the concave portions is welded to increase a joining strength of the joining portion, such a welding process itself is additional one, and the welding portion require a machining process for smoothing it in view of subsequent processes such as an adhering process and an inserting process, resulting in a more complicated fashion.

The present invention has been completed with the above view in mind and it is an object of the present invention to provide a fitting member capable of ensuring strength in a necessary and sufficient manner with a simplified structure without using a welding process or the like.

To achieve the above object, according to a first aspect of the present invention, there is provided a fitting member comprising: a first end portion; a second end portion facing to the first end portion; and a fitting structure having a first engagement portion and a second engagement portion to connect the first end portion and the second end portion with each other by fitting the first engagement portion and the second engagement portion with each other. Here, the fitting structure is defined by making the first engagement portion and the second engagement portion engaged with each other, while making the second engagement portion formed by punching a preform body of the fitting member through the first engagement portion.

In addition to the first aspect, further, the present invention has a second aspect in which the second engagement portion has a shape copying a shape of the first engagement portion.

In addition to the first aspect or the second aspect, furthermore, the present invention has a third aspect in which the first engagement portion includes a convex portion and a concave portion respectively formed with respect to the first end portion, and the second engagement portion includes a concave portion and a convex portion respectively formed with respect to the second end portion in correspondence with the convex portion and the concave portion respectively formed with respect to the first end portion.

In addition to the third aspect, moreover, the present invention has a fourth aspect in which the concave portion and the convex portion of the second end portion have shapes formed by punching the preform body with the convex portion and the concave portion of the first end portion abutting the second end portion.

In addition to the third aspect or the fourth aspect, moreover, the present invention has a fifth aspect in which the convex portion has a shape in which a width of the convex portion becomes wider at an end part of the convex portion, and the concave portion has a shape in which a width of the concave portion becomes wider at an inner part of the concave portion.

In addition to the first aspect or the second aspect, besides, the present invention has a sixth aspect in which the first engagement portion includes a piece member formed of a separate member independent from the preform body, and the second engagement portion includes a hole portion configured to straddle the first end portion and the second end portion.

In addition to the sixth aspect, further, the present invention has a seventh aspect in which the hole portion has a shape formed by punching the preform body with the piece member formed by punching the separate member.

In addition to the sixth aspect or the seventh aspect, furthermore, the present invention has a eighth aspect in which the piece member has a shape in which a width of the piece member becomes wider toward both end portions of the piece member, and the hole portion has a shape in which a width of the hole portion becomes wider at a distant part of the hole portion from the first end portion and the second end portion.

According to the configuration of the first aspect of the present invention, the fitting structure is defined by making the first engagement portion and the second engagement portion engaged with each other, while making the second engagement portion formed by punching the preform body of the fitting member through the first engagement portion. This makes it possible to provide the fitting member capable of ensuring the strength in a necessary and sufficient manner with the simplified structure without using a welding process or the like.

According to the configuration of the second aspect of the present invention, since the second engagement portion has the shape copying the shape of the first engagement portion, it is possible to attain the fitting structure in which the joining faces between the first engagement portion and the second engagement portion are more surely abutted with each other in tight.

According to the configuration of the third aspect of the present invention, the first engagement portion includes the convex portion and the concave portion respectively formed with respect to the first end portion, and the second engagement portion includes the concave portion and the convex portion respectively formed with respect to the second end portion in correspondence with the convex portion and the concave portion respectively formed with respect to the first end portion. This makes it possible to attain the fitting structure in which the joining faces between the first engagement portion and the second engagement portion are more surely abutted with each other in tight, with the simplified structure.

According to the configuration of the fourth aspect of the present invention, the concave portion and the convex portion of the second end portion have the shapes formed by punching the preform body with the convex portion and the concave portion of the first end portion abutting the second end portion. This makes it possible to attain the fitting structure in which the joining faces between the first engagement portion and the second engagement portion are more surely abutted with each other in tight, with the further simplified structure.

According to the configuration of the fifth aspect of the present invention, the convex portion has the shape in which the width of the convex portion becomes wider at the end part of the convex portion, and the concave portion has the shape in which the width of the concave portion becomes wider at the inner part of the concave portion. This makes it possible, even if the fitting structure of so-called dovetail type is employed, that the joining faces between the first engagement portion and the second engagement portion is more surely abutted with each other in tight.

According to the configuration of the sixth aspect of the present invention, the first engagement portion includes the piece member formed of the separate member independent from the preform body, and the second engagement portion includes the hole portion configured to straddle the first end portion and the second end portion. This makes it possible to attain the fitting structure in which the joining faces between the first engagement portion and the second engagement portion are more surely abutted with each other in tight, with the simplified structure.

According to the configuration of the seventh aspect of the present invention, since the hole portion has the shape formed by punching the preform body with the piece member formed by punching the separate member, it is possible to attain the fitting structure in which the joining faces between the first engagement portion and the second engagement portion are more surely abutted with each other in tight, with the further simplified structure.

According to the configuration of the eighth aspect of the present invention, the piece member has the shape in which the width of the piece member becomes wider toward the both end portions of the piece member, and the hole portion has the shape in which the width of the hole portion becomes wider at the distant part of the hole portion from the first end portion and the second end portion. This makes it possible, even if the fitting structure of so-called dovetail type is employed, that the joining faces between the first engagement portion and the second engagement portion is more surely abutted with each other in tight.

### BRIEF DESCRIPTION OF THE DRAWINGS

FIG. 1 is a perspective view showing a collar of a first embodiment according to the present invention;

FIG. 2 is a perspective view showing a first preform body of the collar of the present embodiment;

FIG. 3 is a perspective view showing a second preform body of the collar of the present embodiment;

FIG. 4 shows a manufacturing step of the collar of the present embodiment and positionally corresponds to a B-B cross-section of FIG. 3;

FIG. 5A shows a next manufacturing step of the collar of the present embodiment, positionally corresponding to an A-A cross-section of FIG. 1;

FIG. 5B is a partially enlarged view of FIG. 5A, positionally corresponding to a A-A cross-section of FIG. 1;

FIG. 6 is a perspective view showing a collar of a second embodiment according to the present invention;

FIG. 7 is a perspective view showing a first preform body of the collar with a plate member of the present embodiment;

FIG. 8 shows a manufacturing step of the collar of the present embodiment and positionally corresponds to a D-D cross-section of FIG. 7;

FIG. 9A shows a next manufacturing step of the collar of the present embodiment, positionally corresponding to a C-C cross-section of FIG. 6; and

FIG. 9B is a partially enlarged view of FIG. 9A, positionally corresponding to a C-C cross-section of FIG. 6.

### DETAILED DESCRIPTION OF THE PREFERRED EMBODIMENTS

Now, fitting members of respective embodiments according to the present invention will be described below in detail with reference to the accompanying drawings, while exemplarily referring to collars as the fitting members. Throughout the drawings, an x-axis, a y-axis and a z-axis represent a three-axis orthogonal coordinate system. Incidentally, axial directions of the collars are parallel to the y-axis.

### First Embodiment

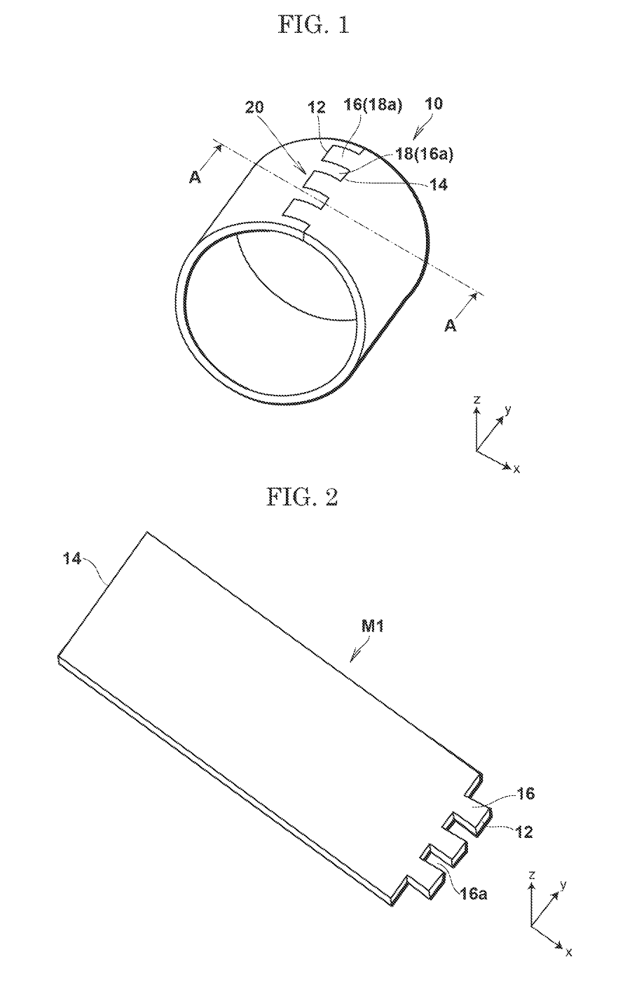

First, a collar of a first embodiment according to the present invention will be described below in detail with reference to FIGS. 1 to 5B.

FIG. 1 is a perspective view showing a collar of the present embodiment.

In the illustrated embodiment, as shown in FIG. 1, a collar 10, made of metal such as iron alloy and aluminum alloy and having an central axis along a direction parallel to the y-axis, has one end portion 12 and the other end portion 14 which are mate end portions facing to each other along a circumferential direction of the collar 10. Here, if the collar 10 is a tubular member, the collar 10 may have a circular cylindrical shape or a square cylindrical shape and, in addition, a sectional shape, cut with an x-z plane, of the collar 10 may be formed in an asymmetrical shape.

More specifically, the one end portion 12 of the collar 10 has a plurality of convex portions 16 aligned along the axial direction and, between the convex portions 16, a plurality of concave portions 16a are formed. Here, if there are provided marginal portions outwardly adjacent to the convex portions 16 at both end portions of the collar 10 in the axial direction, such marginal portions may be regarded as the concave portions 16a. Also, there may be provided only one convex portion 16 formed at the one end portion 12, not limited to plural ones. In such a state, there may be provided concave portions 16a at marginal portions outwardly adjacent to such a single convex portion 16 at both end portions of the collar 10 in the axial direction.

On one hand, the other end portion 14 have a plurality of convex portions 18 aligned along the axial direction to correspondingly enter into the plurality of concave portions 16a formed at the one end portion 12, respectively. Between such respective convex portions 18, concave portions 18a are correspondingly formed such that the plurality of convex portions 16 formed at the one end portion 12 correspondingly enter thereinto, respectively.

Here, the convex portions 16 formed at the one end portion 12 have shapes in which widths of the convex portions 16 become wider, in the axial direction, toward end parts of the convex portions 16 in the circumferential direction of the collar 10, respectively, and the concave portions 16a formed at the one end portion 12 have shapes in which widths of the concave portions 16a become wider, in the axial direction, toward inner parts of the concave portions 16a in the circumferential direction of the collar 10, respectively. On one hand, in correspondence with the shapes of the convex portions 16 and the shapes of the concave portions 16a, both formed at the one end portion 12, the convex portions 18 formed at the other end portion 14 have shapes in which widths of the convex portions 18 become wider, in the axial direction, at end parts of the convex portions 18 in the circumferential direction of the collar 10, respectively, and the concave portions 18a formed at the other end portion 14 have shapes in which widths of the concave portions 18a become wider, in the axial direction, at inner parts of the concave portions 18a in the circumferential direction of the collar 10, respectively.

Also, the collar 10 has a fitting structure 20 connecting the one end portion 12 and the other end portion 14 thereof. Such a fitting structure 20 includes a first engagement portion comprised of the convex portions 16 and the concave portions 16a, both formed at the one end portion 12, and a second engagement portion comprised of the convex portions 18 and the concave portions 18a, both formed at the other end portion 14, to connect the one end portion 12 and the other end portion 14 with each other. That is, the one end portion 12 and the other end portion 14 of the collar 10 are firmly joined by fitting the first engagement portion and the second engagement portion together.

More specifically, such a fitting structure 20 is established by making the convex portions 16 and the concave portions 16a, both formed at the one end portion 12, and the convex portions 18 and the concave portions 18a, both formed at the other end portion 14, engaged with end faces thereof tightly abutted, correspondingly, so as to join the one end portion 12 and the other end portion 14 of the collar 10.

That is, the fitting structure 20, in which the convex portions 16 and the concave portions 16a, both formed at the one end portion 12, and the convex portions 18 and the concave portions 18a, both formed at the other end portion 14, are engaged with the end faces thereof tightly abutted, correspondingly, can be obtained in the following manufacturing method of the collar 10. Next, such a manufacturing method of the collar 10 will be described below in detail further with reference to FIGS. 2 to 5B.

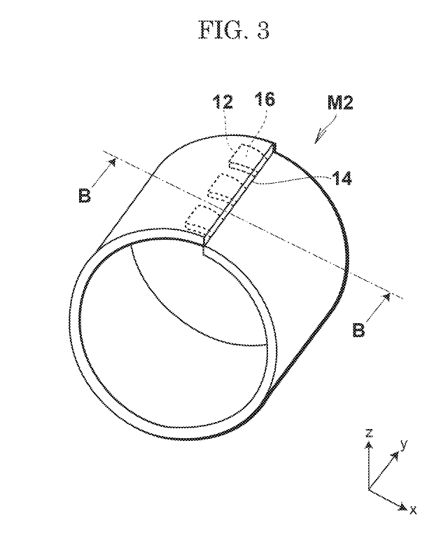

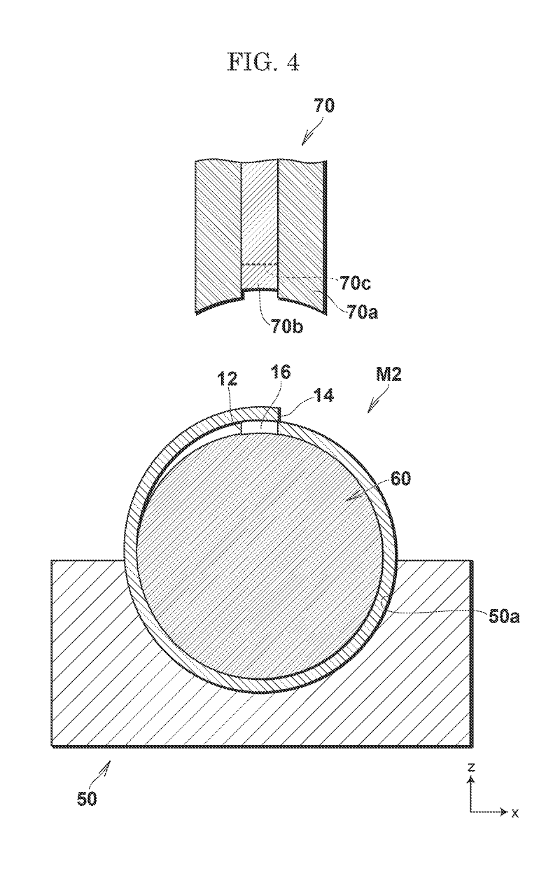

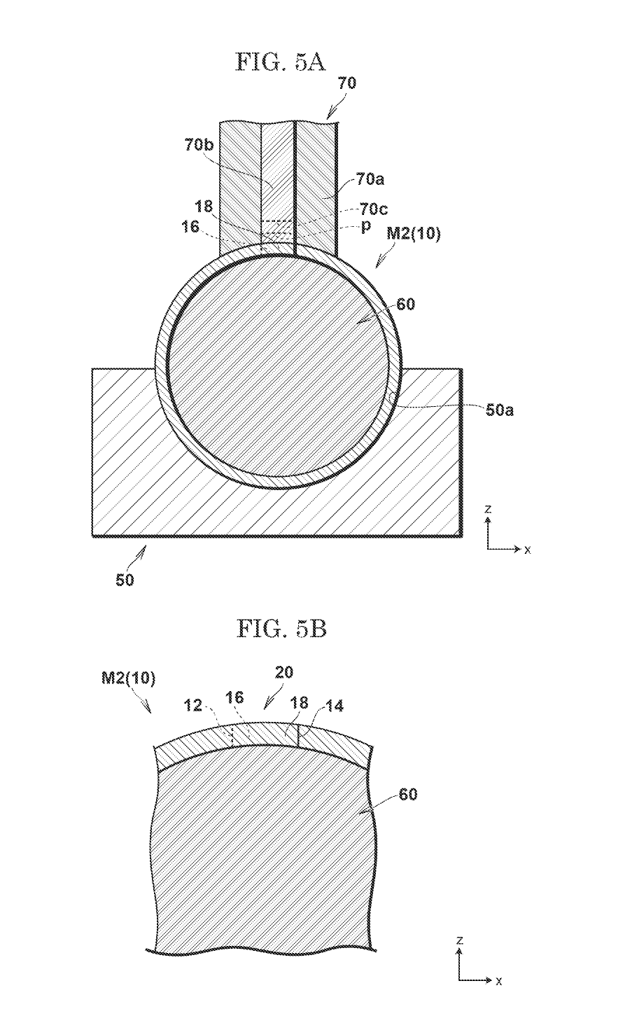

FIG. 2 is a perspective view showing a first preform body of the collar of the present embodiment, and FIG. 3 is a perspective view showing a second preform body of the collar of the present embodiment. FIG. 4 shows a manufacturing step of the collar of the present embodiment and positionally corresponds to a B-B cross-section of FIG. 3. Also, FIG. 5A shows a next manufacturing step of the collar of the present embodiment and FIG. 5B is a partially enlarged view of FIG. 5A, both positionally corresponding to an A-A cross-section of FIG. 1.

In order to manufacture the collar 10, firstly, as show in FIG. 2, a first preform body M1, in which the convex portions 16 and the concave portions 16a sequentially lie along the y-axis at the one end portion 12, is formed by executing a blanking process to a flat plate as a blank member. Here, the other end portion 14 of the first preform body M1 has a straight distal end in which any of convex portions and concave portions are not provided.

Next, as shown in FIG. 3, a second preform body M2, in which the one end portion 12 and the other end portion 14 are overlapped with each other such that the one end portion 12 formed with the convex portions 16 and the concave portions 16a are juxtaposed under the other end portion 14, is formed, by executing a bending process to such a first preform body M1.

Next, as shown in FIG. 4, such a second preform body M2 is mounted on a receiving portion 50a of a lower die 50, and a core die 60, which has an external circumferential surface capable of tightly contacting an internal circumferential surface of the collar 10 as a final product body, is inserted into an internal area of the second preform body M2. Then, with respect to the second preform body M2 in such a state, a punching die 70 is located over the second preform body M2 in opposition to thereto. Here, the punching die 70 has a supporting portion 70a and a punch 70b which is relatively movable in the supporting portion 70a. Also, there are provided recesses 70c which are recessed on a lower surface of the punch 70b in a positive direction of the z-axis. That is, the punch 70b of the punching die 70 is located to face the concave portions 16a of the one end portion 12 of the second preform body M2 causing the other end portion 14 of the second preform body M2 to intervene therebetween, with the recesses 70c of the punch 70b being correspondingly located to face the convex portions 16 of the one end portion 12 of the second preform body M2 causing the other end portion 14 of the second preform body M2 to intervene therebetween, respectively.

Next, as shown in FIGS. 5A and 5B, with respect to the second preform body M2 in such a state, the supporting portion 70a of the punching die 70 is moved downward to press the second preform body M2 into which the core die 60 is inserted, and, also, the punch 70b of the punching die 70 is moved downward to press the other end portion 14 of the second preform body M2. This results that the other end portion 14, pressed by the punch 70b in this manner while abutting the one end portion 12, is partially cut out along a contour of the concave portions 16a to form the convex portions 18 of the other end portion 14, and the resultant convex portions 18 are correspondingly entered, from above, into the concave portions 16a of the one end portion 12 such that the convex portions 18 and the concave portions 16a are engaged together. Simultaneously, portions, corresponding to the convex portions 16 of the one end portion 12, of the other end portion 14, pressed by the punch 70b in this manner while abutting the one end portion 12, are completely cut out along a contour of the convex portions 16 to form fragment pieces “p”, and the resultant fragment pieces “p” are contained in the recesses 70c of the punch 70b, while forming the concave portions 18a of the other end portion 14. And the resultant concave portions 18a are correspondingly entered, from above, around the convex portions 16 of the one end portion 12 such that the concave portions 18a and the convex portions 16 are engaged together. Here, since the convex portions 16 and the concave portions 16a of the one end portion 12 are formed in a sequentially adjacent manner, the concave portions 18a and the convex portions 18 of the other end portion 14 are formed correspondingly in a sequentially adjacent manner.

Then, if the convex portions 18 of the other end portion 14 are correspondingly engaged with the concave portions 16a of the one end portion 12 and the concave portions 18a of the other end portion 14 are correspondingly engaged with the convex portions 16 of the one end portion 12 after the other end portion 14 is punched out through the one end portion 12 of the second preform body M2 by the punch 70b of the punching die 70, both the supporting portion 70a and the punch 70b of the punching die 70 are moved upward. Then, the fragment pieces “p” are dropped downward form the recesses 70c of the punch 70b and discharged outside, and resultantly, there is provided the collar 10 as a final product body having the fitting structure 20 in which the convex portions 16 and the concave portions 16a, both formed at the one end portion 12, and the convex portions 18 and the concave portions 18a, both formed at the other end portion 14, are correspondingly engaged with end faces thereof tightly abutted.

Here, the fitting structure 20 of the collar 10 obtained in this manner was cut out and such a cut surface thereof was observed. This observation shows that the convex portions 16 and the concave portions 16a, both formed at the one end portion 12, and the convex portions 18 and the concave portions 18a, both formed at the other end portion 14, are correspondingly engaged with end faces thereof tightly abutted, without unnecessary gaps or the like therebetween. Also, the predetermined loads both along the axial direction and the circumferential direction were applied to such a fitting structure 20 of the collar 10, but the engagement state thereof was fully maintained. This result shows that the collar 10 has a joining strength enough to be used as a strength member for a motor vehicle or the like, in practical.

Incidentally, although the present embodiment is described as an example in which the one end portion 12 of the collar 10 essentially has at least one convex portion 16, at least one concave portion, of course, may be provided instead of at least one convex portion 16 at the one end portion 12. Associated with this, in a structure in which only one concave portion is formed at the one end portion 12, convex portions formed at the one end portion 12 may exist at both sides adjacent to such a single concave portion in the axial direction.

Also, although the present embodiment is described as an example in which the one end portion 12 formed with the convex portions 16 and the concave portions 16a are firstly juxtaposed under the other end portion 14 having the straight distal end and, then, pressed such that the convex portions 18 and the concave portions 18a are formed at the other end portion 14 while making the fragment pieces “p” contained at the upper region, the one end portion 12 formed with the convex portions 16 and the concave portions 16a may be firstly juxtaposed over the other end portion 14 and then pressed. In this situation, the fragment pieces “p”, which is to be generated when the convex portions 18 and the concave portions 18a are formed at the other end portion 14, may be dropped downward and discharged outside. Of course, the one end portion 12 may have a straight distal end and on one hand, the convex portions and the concave portions may be previously formed at the other end portion 14 to form a similar fitting structure.

Also, a member, in which such an engagement structure is to be formed, is not limited to a tubular member formed of a sheet of plate member joined by a fitting structure, and it may be a tubular member formed of plural sheets of plate member while joining the plural sheets of plate member with respective fitting structures or may be a bent or curved plate member in which end portions thereof have free ends without joining the end portions.

With such a structure in the present embodiment mentioned above, the fitting structure is defined by making the first engagement portion and the second engagement portion engaged with each other, while making the second engagement portion formed by punching the preform body of the fitting member through the first engagement portion. This makes it possible to provide the fitting member capable of ensuring the strength in a necessary and sufficient manner with the simplified structure without using a welding process or the like.

Further, since the second engagement portion has the shape copying the shape of the first engagement portion, it is possible to attain the fitting structure in which the joining faces between the first engagement portion and the second engagement portion are more surely abutted with each other in tight.

Furthermore, the first engagement portion includes the convex portion and the concave portion respectively formed with respect to the first end portion, and the second engagement portion includes the concave portion and the convex portion respectively formed with respect to the second end portion in correspondence with the convex portion and the concave portion respectively formed with respect to the first end portion. This makes it possible to attain the fitting structure in which the joining faces between the first engagement portion and the second engagement portion are more surely abutted with each other in tight, with the simplified structure.

Moreover, the concave portion and the convex portion of the second end portion have the shapes formed by punching the preform body with the convex portion and the concave portion of the first end portion abutting the second end portion. This makes it possible to attain the fitting structure in which the joining faces between the first engagement portion and the second engagement portion are more surely abutted with each other in tight, with the further simplified structure.

In addition, the convex portion has the shape in which the width of the convex portion becomes wider at the end part of the convex portion, and the concave portion has the shape in which the width of the concave portion becomes wider at the inner part of the concave portion. This makes it possible, even if the fitting structure of so-called dovetail type is employed, that the joining faces between the first engagement portion and the second engagement portion is more surely abutted with each other in tight.

### Second Embodiment

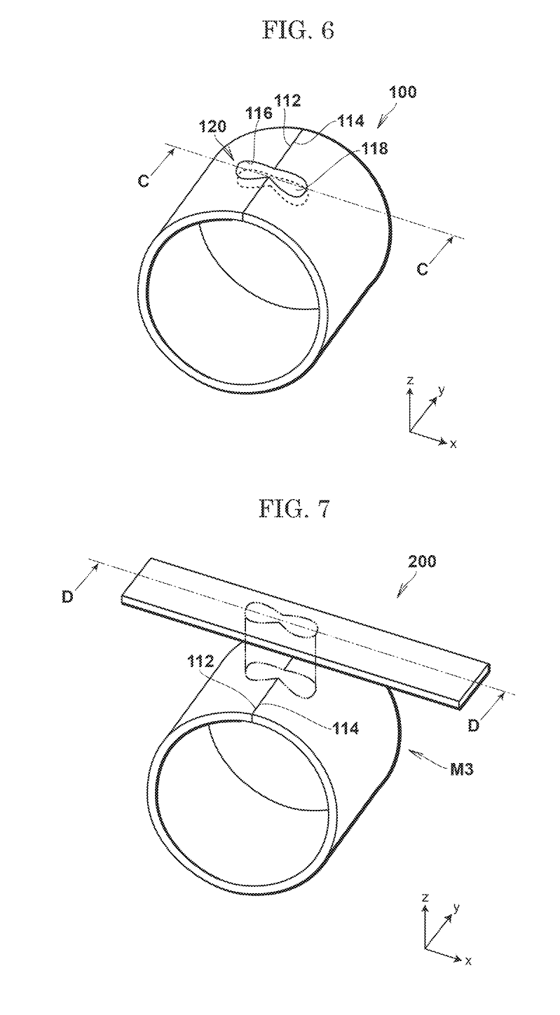

Next, a collar of a second embodiment according to the present invention will be described below in detail with reference to FIGS. 6 to 9B.

FIG. 6 is a perspective view showing a collar of the present embodiment.

A collar 100 of the present embodiment mainly differs from the collar 10 of the first embodiment, in that a fitting structure 120 has a through hole 116 and an engagement piece 118, with the remaining structure remained identical. Therefore, the present embodiment will be described below with a focus on such differing points with like component parts bearing the same reference numerals to suitably simplify or omit descriptions thereof.

More specifically, as shown in FIG. 6, although the collar 100 has one end portion 112 and the other end portion 114 which are mate end portions facing to each other along a circumferential direction of the collar 100, the one end portion 112 and the other end portion 114 have the through hole 116 formed to straddle the one end portion 112 and the other end portion 114 abutted together. Also, the engagement piece 118, made of metal such as iron alloy and aluminum alloy, are fitted into the through hole 116.

Here, the through hole 116, formed to straddle the one end portion 112 and the other end portion 114, has a shape in which a width of the through hole 116 becomes wider, in the axial direction, at distant parts of the through hole 116 in the circumferential direction of the collar 100 from the one end portion 112 and the other end portion 114, respectively. Also, the engagement piece 118 has a shape in which a width of the engagement piece 118 becomes wider, in the axial direction, at both end parts of the engagement piece 118 in the circumferential direction of the collar 100, in correspondence with the shapes of the through hole 116, respectively.

Also, the collar 100 has the fitting structure 120 connecting the one end portion 112 and the other end portion 114 thereof. Such a fitting structure 120 includes a first engagement portion comprised of the engagement piece 118, and a second engagement portion comprised of the through hole 116, formed to straddle the one end portion 112 and the other end portion 114, to connect the one end portion 112 and the other end portion 114 with each other. That is, the one end portion 112 and the other end portion 114 of the collar 100 are firmly joined by fitting the first engagement portion and the second engagement portion together.

More specifically, such a fitting structure 120 is established by making an internal circumferential surface of the through hole 116, formed to straddle the one end portion 112 and the other end portion 114, and an outer circumferential surface of the engagement piece 118 engaged together, while being tightly abutted along entire lengths thereof, so as to join the one end portion 112 and the other end portion 114 of the collar 100.

That is, the fitting structure 120, in which the internal circumferential surface of the through hole 116, formed to straddle the one end portion 112 and the other end portion 114, and the outer circumferential surface of the engagement piece 118 engaged together while being tightly abutted along the entire lengths thereof, can be obtained in the following manufacturing method of the collar 100. Next, such a manufacturing method of the collar 100 will be described below in detail further with reference to FIGS. 7 to 9B.

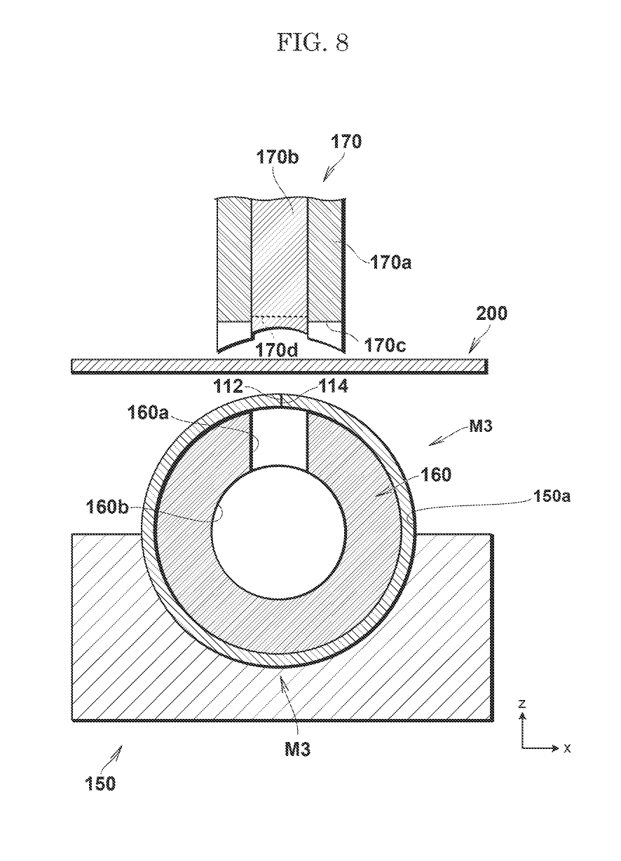

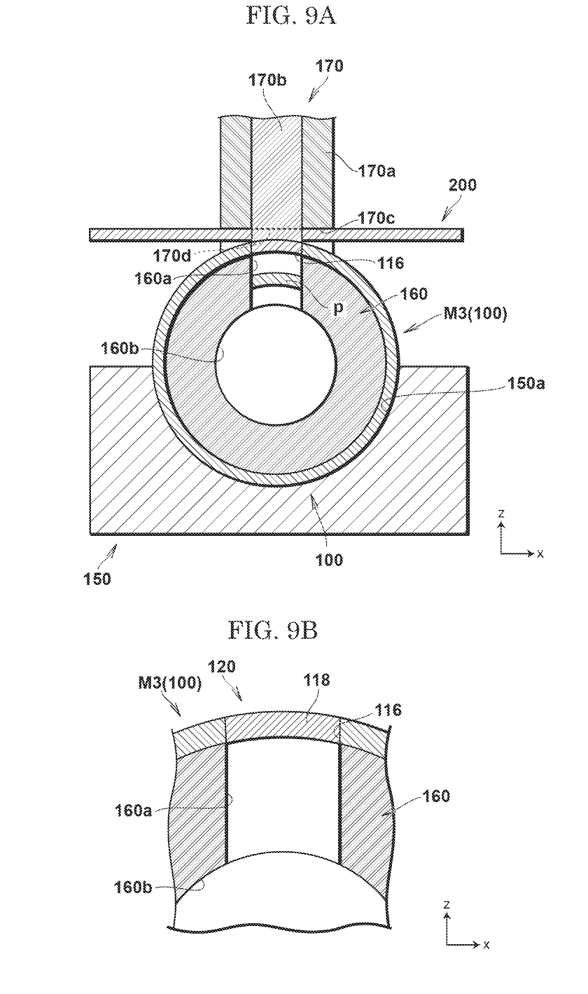

FIG. 7 is a perspective view showing a first preform body of the collar with a plate member of the present embodiment. FIG. 8 shows a manufacturing step of the collar of the present embodiment and positionally corresponds to a D-D cross-section of FIG. 7. Also, FIG. 9A shows a next manufacturing step of the collar of the present embodiment and FIG. 9B is a partially enlarged view of FIG. 9A, both positionally corresponding to a C-C cross-section of FIG. 6.

In order to manufacture the collar 100, firstly, as show in FIG. 7, a first preform body M3 as a tubular member, in which the one end portion 112 and the other end portion 114 are abutted, is obtained by executing a bending process to a flat plate as a blank member, and, then, a plate member 200 is located in opposition to such a first preform body M3.

More specifically, as shown in FIG. 8, such a first preform body M3 is mounted on a receiving portion 150a of a lower die 150, and, also, a core die 160 is inserted into an internal area of the first preform body M2. Here, the core die 160 has an external circumferential surface capable of tightly contacting an internal circumferential surface of the collar 100 as a final product body. Also, the core die 160 is formed with a through hole 160a and a central hole 160b communicating the through hole 160a to be opened along a direction of the y-axis.

Also, with respect to the first preform body M3 in such a state, the plate member 200 is located over the first preform body M3 in opposition to thereto and, further, a punching die 170 is located over the plate member 200 in opposition to thereto. Here, the punching die 170 has a supporting portion 170a and a punch 170b which is relatively movable in the supporting portion 170a. Also, there are provided recesses 170c, which are recessed on a lower surface of the supporting portion 170a in the positive direction of the z-axis to prevent the supporting portion 170a from unnecessarily interfering the plate member 200, and a recess 170d which is recessed on a lower surface of the punch 170b in the positive direction of the z-axis. In addition, the through hole 160a of the core die 160 is correspondingly located to the punch 170b to have a similar size to that of the punch 170b as viewed in a direction of the z-axis.

Next, as shown in FIGS. 9A and 9B, with respect to the first preform body M3 in such a state, the supporting portion 170a of the punching die 170 is moved downward to press the first preform body M3 with the recesses 170c, while maintaining the first preform body M3 in a state in which the first preform body M3 does not interfere the plate member 200 due to the recesses 170c, and, also, the punch 170b of the punching die 170 is moved downward to press, in addition to the plate member 200, the one end portion 112 and the other end portion 114 of the first preform body M3, while causing the plate member 200 to intervene between the punch 170b and both the one end portion 112 and the other end portion 114. This results in that the plate member 200, pressed by the punch 170b in this manner, is partially cut out along a contour defined with the recesses 170d to form the engagement piece 118. Then, since such an engagement piece 118 abuts the one end portion 112 and the other end portion 114 of the first preform body M3, the engagement piece 118 presses and punches out the one end portion 112 and the other end portion 114 of the first preform body M3 to form the through hole 116 into which the engagement piece 118 is entered, from above, such that the engagement piece 118 and the through hole 116 are engaged together. Simultaneously, a portion of the one end portion 112 and the other end portion 114 of the first preform body M3 punched out in this manner is formed as a fragment piece “p”, and the resultant fragment piece “p” is dropped downward to the central hole 160b through the through hole 160a of the core die 160 and discharged outside

Then, if the engagement piece 118 is engaged with the through hole 116 after the one end portion 112 and the other end portion 114 of the first preform body M3 is punched out by the punch 170b of the punching die 170 with the plate member 200 intervening, both the supporting portion 170a and the punch 170b of the punching die 170 are moved upward. Then, there is resultantly provided the collar 100 as a final product body having the fitting structure 120 in which the through hole 116, formed at the one end portion 112 and the other end portion 114, and the engagement piece 118, formed from the plate member 200, are engaged together with end faces thereof tightly abutted.

Here, the fitting structure 120 of the collar 100 obtained in this manner was cut out and such a cut surface thereof was observed. This observation shows that the through hole 116, formed at the one end portion 112 and the other end portion 114, and the engagement piece 118, formed from the plate member 200, are engaged with end faces thereof tightly abutted, without an unnecessary gap or the like therebetween. Also, the predetermined loads both along the axial direction and the circumferential direction were applied to such a fitting structure 120 of the collar 100, but the engagement state thereof was fully maintained. This result shows that the collar 100 has a joining strength enough to be used as a strength member for a motor vehicle or the like, in practical.

Incidentally, although the present embodiment is described as an example in which only one engagement piece 118 is formed, a plurality of engagement pieces 118, of course, may be provided while preferably setting a width of the plate member 200 or the like. Associated with this, in a structure in which the plurality of engagement pieces 118 are provided, a plurality of through holes 116 may be formed.

Also, a member, in which such an engagement structure is to be formed, is not limited to a tubular member formed of a sheet of plate member joined by a fitting structure, and it may be a tubular member formed of plural sheets of plate member while joining the plural sheets of plate member with respective fitting structures or may be a bent or curved plate member in which end portions thereof have free ends without joining the end portions.

With such a structure in the present embodiment mentioned above, the first engagement portion includes the piece member formed of the separate member independent from the preform body, and the second engagement portion includes the hole portion configured to straddle the first end portion and the second end portion. This makes it possible to attain the fitting structure in which the joining faces between the first engagement portion and the second engagement portion are more surely abutted with each other in tight, with the simplified structure.

Further, since the hole portion has the shape formed by punching the preform body with the piece member formed by punching the separate member, it is possible to attain the fitting structure in which the joining faces between the first engagement portion and the second engagement portion are more surely abutted with each other in tight, with the further simplified structure.

Furthermore, the piece member has the shape in which the width of the piece member becomes wider toward the both end portions of the piece member, and the hole portion has the shape in which the width of the hole portion becomes wider at the distant part of the hole portion from the first end portion and the second end portion. This makes it possible, even if the fitting structure of so-called dovetail type is employed, that the joining faces between the first engagement portion and the second engagement portion is more surely abutted with each other in tight.

As described above, according to the present invention, there can be provided a fitting member capable of ensuring a strength in a necessary and sufficient manner with a simplified structure without using a welding process or the like to have general-purpose and universal character based on which it is expected to have wide applications to strength members of moving object such as vehicles.

Reference is hereby made to a Patent Application No. TOKUGAN 2010-97336 with a filing date of Apr. 20, 2010 in Japan, the entire content of which is incorporated herein by reference.

The present invention is not limited to the embodiments described above in respect of a kind, placement and the number of the component parts and it is of course to be understood that the relevant component parts may be suitably replaced by those having equivalent advantageous effects and alterations may be suitably made without departing from the scope of the present invention, in light of the teachings. The scope of the invention is defined with reference to the following claims.

What is claimed is:

1. A fitting member comprising:
a first end portion;
a second end portion facing to the first end portion; and
a fitting structure having a first engagement portion and a second engagement portion to connect the first end portion and the second end portion with each other by fitting the first engagement portion and the second engagement portion with each other,
wherein the fitting structure is defined by making the first engagement portion and the second engagement portion engaged with each other, while making the second engagement portion formed by punching a preform body of the fitting member through the first engagement portion.

2. The fitting member according to claim 1, wherein the second engagement portion has a shape copying a shape of the first engagement portion.

3. The fitting member according to claim 1, wherein the first engagement portion includes a convex portion and a concave portion respectively formed with respect to the first end portion, and the second engagement portion includes a concave portion and a convex portion respectively formed with respect to the second end portion in correspondence with the convex portion and the concave portion respectively formed with respect to the first end portion.

4. The fitting member according to claim 3, wherein the concave portion and the convex portion of the second end portion have shapes formed by punching the preform body with the convex portion and the concave portion of the first end portion abutting the second end portion.

5. The fitting member according to claim 3, wherein the convex portion has a shape in which a width of the convex portion becomes wider at an end part of the convex portion, and the concave portion has a shape in which a width of the concave portion becomes wider at an inner part of the concave portion.

6. The fitting member according to claim 1, wherein the first engagement portion includes a piece member formed of a separate member independent from the preform body, and the second engagement portion includes a hole portion configured to straddle the first end portion and the second end portion.

7. The fitting member according to claim 6, wherein the hole portion has a shape formed by punching the preform body with the piece member formed by punching the separate member.

8. The fitting member according to claim 6, wherein the piece member has a shape in which a width of the piece member becomes wider toward both end portions of the piece member, and the hole portion has a shape in which a width of the hole portion becomes wider at a distant part of the hole portion from the first end portion and the second end portion.
